(19) United States
(12) Patent Application Publication
(10) Pub. No.: US 2025/0055504 A1
(43) Pub. Date: Feb. 13, 2025

(54) LINE OF SIGHT DETERMINATION BASED ON POLARIZATION CHARACTERISTICS

(71) Applicant: QUALCOMM Incorporated, San Diego, CA (US)

(72) Inventors: Danlu ZHANG, San Diego, CA (US); Sony AKKARAKARAN, Poway, CA (US); Amichai SANDEROVICH, Atlit (IL); Bala RAMASAMY, San Marcos, CA (US)

(21) Appl. No.: 18/718,414

(22) PCT Filed: Nov. 22, 2022
(86) PCT No.: PCT/US2022/050787

§ 371 Date: Jun. 10, 2024

(30) Foreign Application Priority Data
Feb. 9, 2022 (IL) 290478

(51) Int. Cl. H04B 7/0404; G01S 5/02; G01S 11/02; H04B 7/0456; H04B 7/10

(52) U.S. Cl. CPC H04B 7/0404; G01S 5/0218; G01S 11/02; H04B 7/0469; H04B 7/10

(57) ABSTRACT

Method and apparatus to determine a line-of-sight (LOS) path based at least on polarization characteristics. The apparatus determines a polarization used by a transmitter for at least one RS. The apparatus receives the at least one RS with a first received polarization in a first configuration and a second received polarization in a second configuration that is different from the first configuration. The apparatus measures polarization characteristics of the first received polarization and the second received polarization. The apparatus determines whether the at least one RS was received in a LOS path from the transmitter based on the measured polarization characteristics and expected received polarization characteristics, wherein the expected received polarization characteristics are based on the determined polarization used by the transmitter.

### CROSS-REFERENCE TO RELATED APPLICATION

This application claims the benefit of Israel Patent Application Serial No. 290478, entitled “LINE OF SIGHT DETERMINATION BASED ON POLARIZATION CHARACTERISTICS” and filed on Feb. 9, 2022, which is expressly incorporated by reference herein in its entirety.

### TECHNICAL FIELD

The present disclosure relates generally to communication systems, and more particularly, to techniques for determining a line of sight (LOS) path based at least on polarization characteristics.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a base station. The device may be a processor and/or a modem at a base station or the base station itself. The apparatus may be a device at a UE. The device may be a processor and/or a modem at a UE or the UE itself. The apparatus determines a polarization used by a transmitter for at least one RS. The apparatus receives the at least one RS with a first received polarization in a first configuration and a second received polarization in a second configuration that is different from the first configuration. The apparatus measures polarization characteristics of the first received polarization and the second received polarization. The apparatus determines whether the at least one RS was received in a LOS path from the transmitter based on the measured polarization characteristics and expected received polarization characteristics, wherein the expected received polarization characteristics are based on the determined polarization used by the transmitter.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of a transmission antenna polarization and a receiver antenna polarization.

FIG. 5 is a diagram illustrating an example of a transmission antenna polarization and a receive antenna polarization.

FIG. 6 is a diagram 600 illustrating an example of a receiver.

FIG. 7 is a call flow diagram of signaling between a receiver and a transmitter.

FIG. 8 is a flowchart of a method of wireless communication.

FIG. 9 is a flowchart of a method of wireless communication.

FIG. 10 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

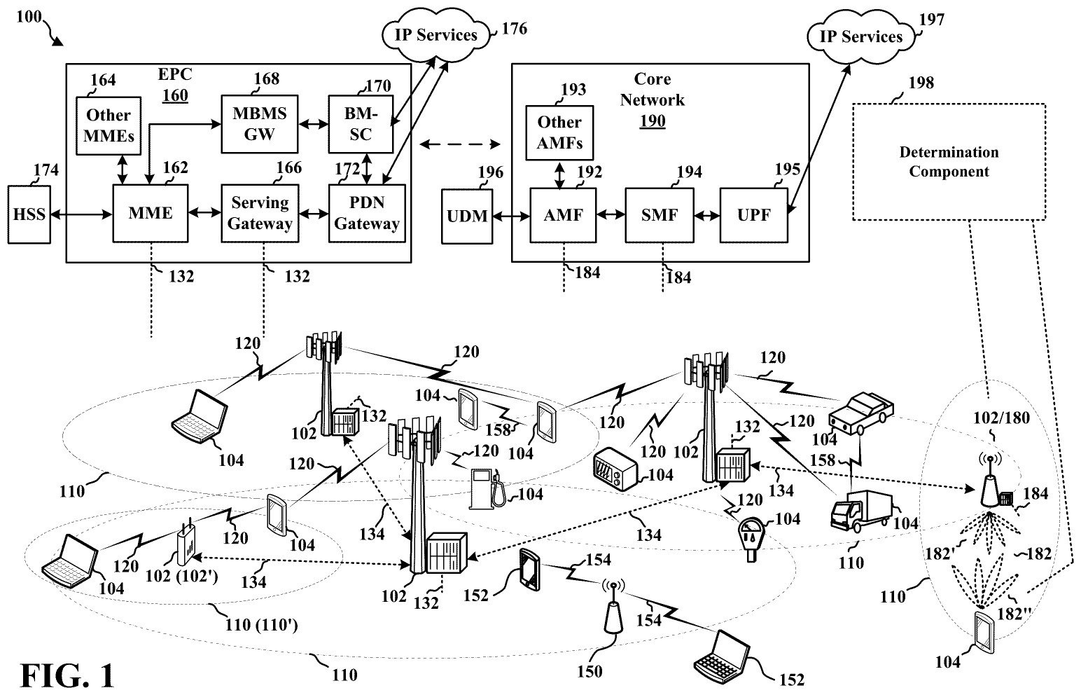

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the receiver (e.g., UE 104 or base station 180) may be configured to determine a line of sight path based at least on polarization characteristics. For example, the receiver (e.g., UE 104 or base station 180) may comprise a determination component 198 configured to determine a line of sight path based at least on polarization characteristics. The receiver may determine a polarization used by a transmitter for at least one RS. The receiver may receive the at least one RS with a first received polarization in a first configuration and a second received polarization in a second configuration that is different from the first configuration. The receiver may measure polarization characteristics of the first received polarization and the second received polarization. The receiver may determine whether the at least one RS was received in a LOS path from the transmitter based on the measured polarization characteristics and expected received polarization characteristics. The expected received polarization characteristics are based on the determined polarization used by the transmitter.

Although the following description may be focused on 5G NR, the concepts described herein may be applicable to other similar areas, such as LTE, LTE-A, CDMA, GSM, and other wireless technologies.

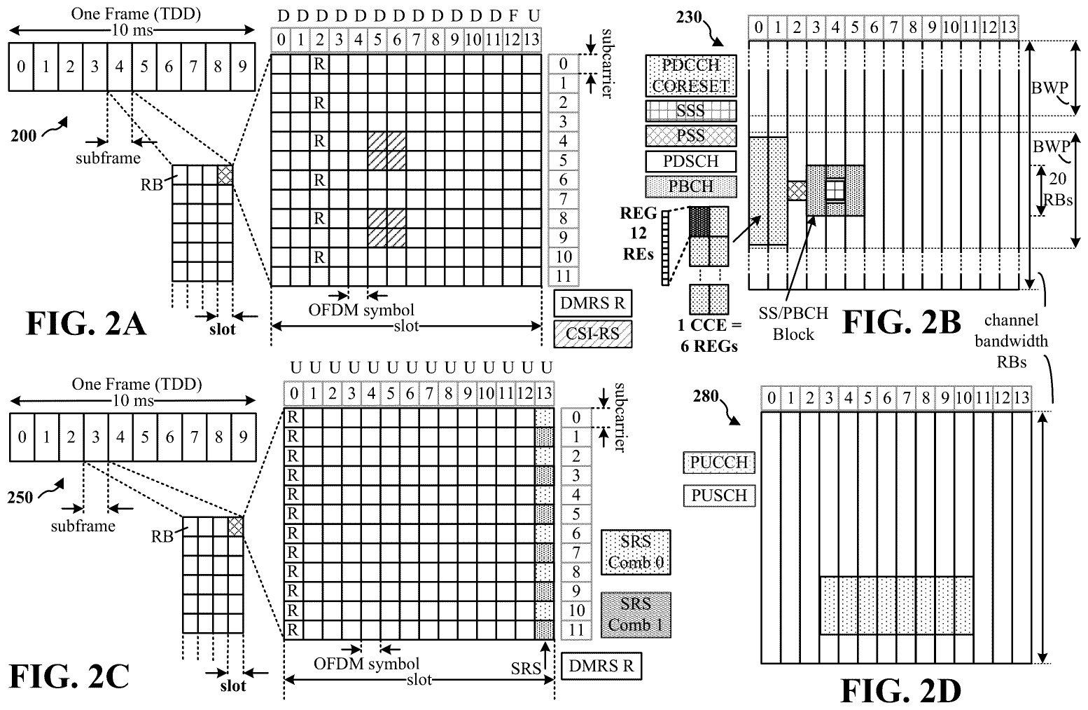

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15 [KHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ*15} kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

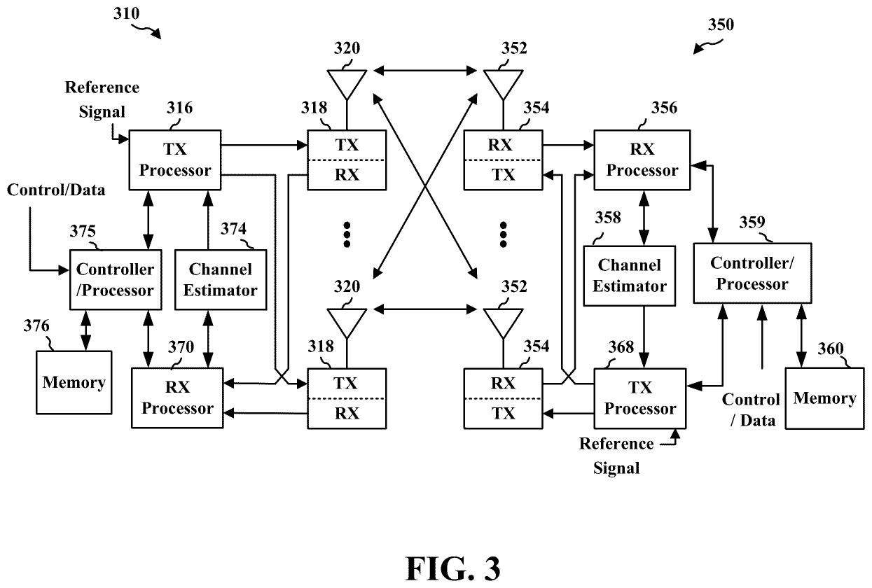

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 198 of FIG. 1.

In wireless communications, for example in 5G or LTE positioning, to determine precise positioning based on signals from ground stations (e.g., base stations), a determination of whether a receive path is an LOS path or not should be performed, because LOS receive paths may be directly used to calculate the positioning. If the receive path is reflected, then the reflection may affect or change the polarization of the incident wave in the reflective wave. In instances where it is known that the receive path is reflected, the location of the reflective source should be determined or adjustments should be made before calculating the distance or positioning.

Aspects presented herein provide a configuration for determining whether a receive path is a LOS path or not. In some instances, a determination whether a path is a LOS path or not may be important for positioning calculation. As such, utilizing polarization characteristics of the received signal may be examined. For example, a receiver may be configured to determine that the path is a LOS path or not based at least on polarization characteristics of the received signal. In some instances, if the receiver sees the same or similar polarization characteristics for the received signal and an expected received signal, then the receiver may determine that the path is a LOS path.

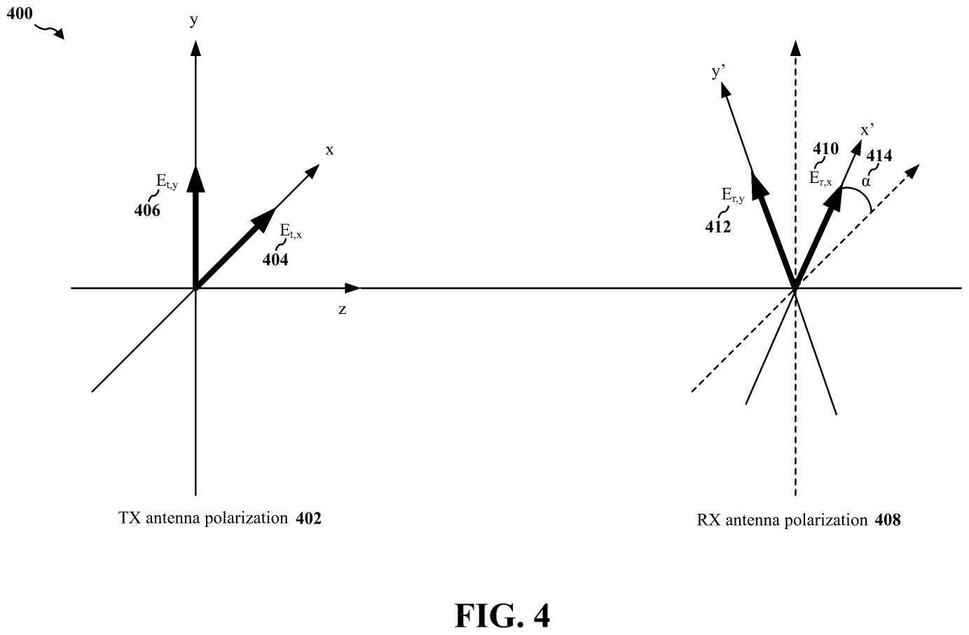

FIG. 4 is a diagram 400 illustrating an example of a transmission antenna polarization 402 and a receive antenna polarization 408. A waveform may travel in a z direction and may have a polarization of (E_{t,x}, E_{t,y}, 0). The E_{t,x} component 404 may be along the x axis, while the E_{t,y} component 406 may be along the y axis. If the receiver panel is perpendicular to z but has cross-polarized antennas at an angle of α 414, assuming perfect polarization at the cross-polarized antennas, the receiver may detect two polarizations. The E_{r,x} component 410 received at the receiver may be along an x′ axis that is rotated from the x axis by the angle of α 414. E_{r,y} component 412 received at the receiver may be along a y′ axis that is also rotated from the y axis by the angle of α 414. However, the receiver may be unable to calculate the angle α 414 and recover the original polarization vector.

In instances where a single transmission polarization configuration with a rotation of an angle α along the z axis, assuming that (E_{t,x}, E_{t,y}, 0) becomes (E_{r,x}, E_{r,y}, 0) after a rotation of angle α along the z axis:

$$[ \begin{matrix}{E}_{r , x} \\ {E}_{r , y} \\ 0\end{matrix} ] \sim [ \begin{matrix}cos α & sin α & 0 \\ - sin α & cos α & 0 \\ 0 & 0 & 1\end{matrix} ] [ \begin{matrix}{E}_{t , x} \\ {E}_{t , y} \\ 0\end{matrix} ] = [ \begin{matrix}cos α {E}_{t , x} + sin α {E}_{t , y} \\ - sin α {E}_{t , x} + cos α {E}_{t , y} \\ 0\end{matrix} ]$$

If we assume that |E_{t,y}|=|E_{t,x}|, and denote that E_{t,y}=E_{t,x}e^{jθ}, and if preservation of relative amplitude is required, namely |E_{r,x}|=|E_{r,y}|, then the following properties may apply:

$$\begin{matrix}\vert cos α + sin α {e}^{j θ} \vert = \vert - sin α + cos α {e}^{j θ} \vert \\ \vert cos α + sin α cos θ - j sin α sin θ \vert = \vert - sin α + cos α cos θ + j cos α sin θ \vert \\ sin α cos αcosθ = 0 \\ sin 2 α cos θ = 0\end{matrix}$$

When cos θ=0 for all angle α with |E_{r,x}|=|E_{r,y}|, namely θ=±π/2, then angle of (E_{r,x}, E_{r,y}, 0)=θ=±π/2. As such, circular polarization may have amplitude and angle preservation for all rotation angles along the z axis in instances of a single transmission polarization configuration. In such instances, the receiver may have knowledge of a single transmission polarization configuration, that circular polarization is used, or that the information of clockwise or counter-clockwise rotation is not necessary.

If multiple polarization configuration of a signal from a single antenna port are allowed over time, the following schemes may enable LOS path determination. For example, a pattern with two polarization configurations interlaced in time. The two polarization configurations may comprise two perpendicular linear polarizations (e.g., clockwise or counter-clockwise circular polarizations, orthogonal elliptical polarization, or the like). The pattern may be pseudorandom for enhanced diversity. In such instances, the receiver may have knowledge of the polarization pattern (e.g., amplitude and phase). The receiver may also have knowledge that the multiple configuration may change over a certain period of time, such that both polarizations may be transmitted with equal amplitude and for an equal amount of time (e.g., polarization mixing). The receiver may determine LOS path status by observing the polarization for a period of time that exceeds a designated period of time. In some aspects, the designated period of time may be preconfigured in the receiver or may be configured via signaling from a transmitter.

In instances of multiple antenna ports, if multiple antenna ports may be used for the transmission of the RS, the multiple antenna ports may use different polarization configurations. For example, each port may have a fixed polarization configuration (e.g., linear, circular, elliptical), where the polarization configurations may be different across the antenna ports. In some aspects, the polarization of each antenna port may vary over time in a pattern. The receiver may have knowledge of the polarization pattern (e.g., amplitude and phase). The receiver may also have knowledge that the multiple configurations may change over known period of time, such that both polarizations may be transmitted with equal amplitude and for an equal amount of time (e.g., polarization mixing). The receiver may determine LOS path status by observing the polarization for an extended period of time than the designated period of time. In some aspects, the designated period of time may be preconfigured in the receiver or may be configured via signaling from a transmitter.

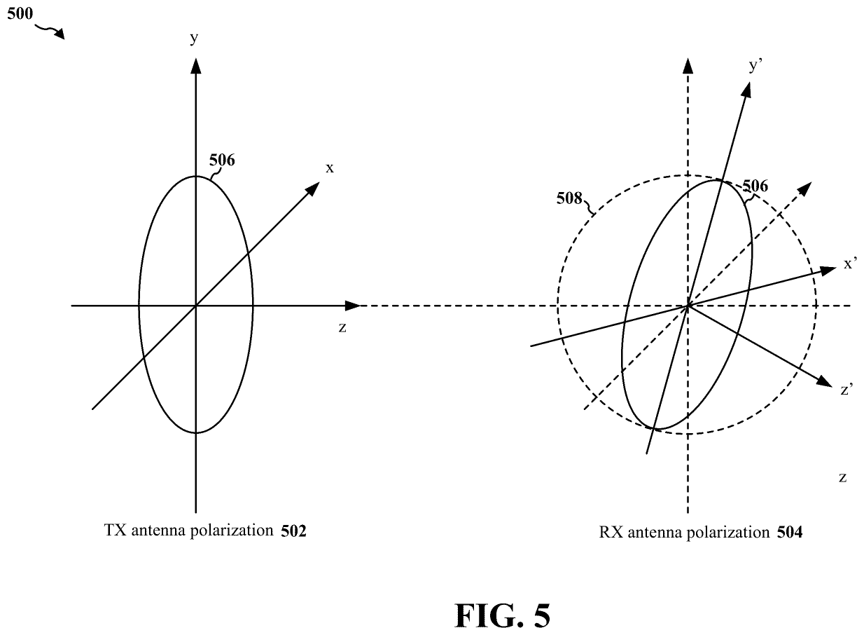

FIG. 5 is a diagram 500 illustrating an example of a transmission antenna polarization 502 and a receive antenna polarization 504. In the diagram 500 of FIG. 5, rotation may occur along the x axis and the y axis. If the receiver panel is not perpendicular to the z axis, the receiver panel may not be able to detect perfect circular polarization 508. Instead, the transmission polarization 506 may be received by the receiver, such that the transmission polarization 506 is rotated along the x′ axis and the y′ axis. For example, under the assumption that the coordinates of the receive plane rotates (−γ, −β, 0) with respect to the x axis, y axis, and z axis. The transmission plane may be rotated by the angles (0, β, γ) with respect to the z axis, y axis, and x axis of the receiver coordinates. Without losing generality, we may assume that α=0 when circular polarization is used.

A point with receiver coordinates of (x′, y′, z′) may have its coordinates at rotation (−γ, −β, 0) with respect to the x axis, y axis, and z axis, which may be represented as follows:

$$[ \begin{matrix}{E}_{r , x} \\ {E}_{r , y} \\ 0\end{matrix} ] = [ \begin{matrix}cos β & 0 & - sin β \\ sin β sin γ & cos γ & cos β sin γ \\ sin β cos γ & - sin γ & cos β cos γ\end{matrix} ] [ \begin{matrix}{E}_{t , x} \\ {E}_{t , y} \\ 0\end{matrix} ]$$

The amplitude and phase of circular polarization may be broken by the rotation of β and γ.

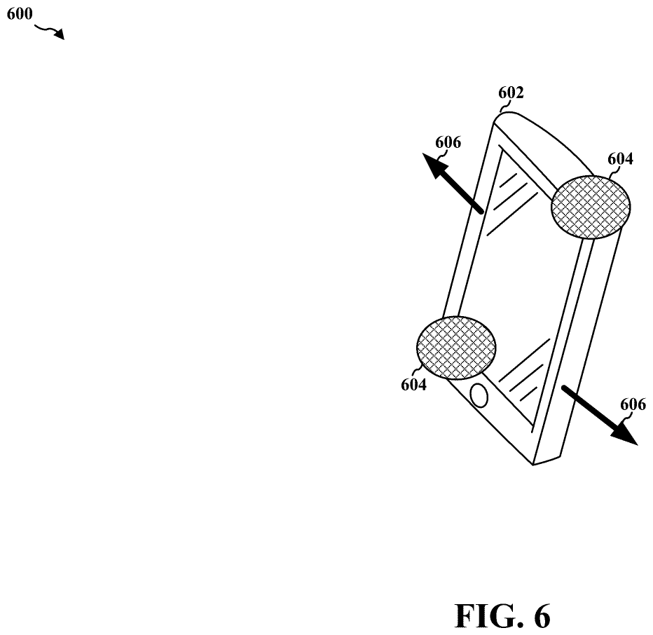

FIG. 6 is a diagram 600 illustrating an example of a receiver. The receiver 602 may comprise a UE comprising chip arrays 604, 604 and slot arrays 606, 606. If the receiver 602 has cross-polarized antennas and multiple of them to cover all three axes (e.g., x, y, z), the antenna output polarization vectors may be denoted as (E_{ant,x}, E_{ant,y}, E_{ant,z}). The antenna response matrix may be denoted as Hₐₙₜ which may comprise a 3×3 matrix, which may represent the antenna response of each axis to polarized signal along all three axes. Under the assumption that Hₐₙₜ may be inverted, which may require that each antenna is not purely polarization, namely, that each antenna responses to some extent signal from other polarization direction. The total response from the transmission to receiver antenna may be as follows:

$$[ \begin{matrix}{E}_{ant , x} \\ {E}_{ant , y} \\ {E}_{ant , z}\end{matrix} ] = {H}_{ant} [ \begin{matrix}cos β & 0 & - sin β \\ sin β sin γ & cos γ & cos β sin γ \\ sin β cos γ & - sin γ & cos β cos γ\end{matrix} ] [ \begin{matrix}{E}_{t , x} \\ {E}_{t , y} \\ 0\end{matrix} ]$$

From the antenna response, the polarization in the transmission signal may be estimated as follows:

$$[ \begin{matrix}{E}_{t , x} \\ {E}_{t , y} \\ {E}_{t , z}\end{matrix} ] = {[ \begin{matrix}cos β & 0 & - sin β \\ sin β sin γ & cos γ & cos β sin γ \\ sin β cos γ & - sin γ & cos β cos γ\end{matrix} ]}^{- 1} {{H}_{ant}}^{- 1} [ \begin{matrix}{E}_{ant , x} \\ {E}_{ant , y} \\ {E}_{ant , z}\end{matrix} ] = [ \begin{matrix}cos β & sin β sin γ & sin β cos γ \\ 0 & cos γ & - sin γ \\ - sin β & cos β sin γ & cos β cos γ\end{matrix} ] {{H}_{ant}}^{- 1} [ \begin{matrix}{E}_{ant , x} \\ {E}_{ant , y} \\ {E}_{ant , z}\end{matrix} ]$$

The receiver may transform the polarization vector in antenna response (E_{ant,x}, E_{ant,y}, E_{ant,z}) to the polarization in the received waveform (E_{r,x}, E_{r,y}, E_{r,z}) based on Hₐₙₜ⁻¹. The receiver may transform the polarization vector (E_{r,x}, E_{r,y}, E_{r,z}) to the estimated polarization vector (\tilde{E}_{t,x}, \tilde{E}_{t,y}, \tilde{E}_{t,z}). The angles of β and γ may be estimated by the antenna array, which may be equivalent to estimating the angle of arrival.

To determine a LOS path, the parameter of (\tilde{E}_{t,x}, \tilde{E}_{t,y}, \tilde{E}_{t,z}) may be based on knowledge of the polarization characteristics. With a single fixed transmission polarization configuration of either clockwise or counter-clockwise circular polarization may comprise \tilde{E}_{t,x}≈\tilde{E}_{t,y}, and phase difference between \tilde{E}_{t,x} and \tilde{E}_{t,y} close to 90 degrees (e.g., ignoring the error probability between 90 and −90 degrees). A single antenna port with varying transmission polarization configurations or multiple antenna ports, and polarization patterns are such that both polarization directions may have the same signal strength after average or accumulation at a certain point of time (e.g., \tilde{E}_{t,x}≈\tilde{E}_{t,y}). In some aspects, if the phase difference patterns are known, then the phase difference between \tilde{E}_{t,x} and \tilde{E}_{t,y} may be close to the expected value. The assumption of detecting polarization along all x, y, and z directions makes it desirable to have antennas which have their primary polarization directions covering all three directions. At least one advantage of the disclosure is the applicability to both uplink and downlink. The transmitter and receiver may comprise a UE, a base station, or any other entity in wireless networks. In addition, since wave propagations may be estimated, multiple receive antennas may be required, such that a higher number of antennas may be desirable. As such, the disclosure may be well suited for base station based on uplink transmissions. However, the disclosure may also be suited for uplink transmissions on other wireless devices and the disclosure is not intended to be limited to uplink transmission for base stations.

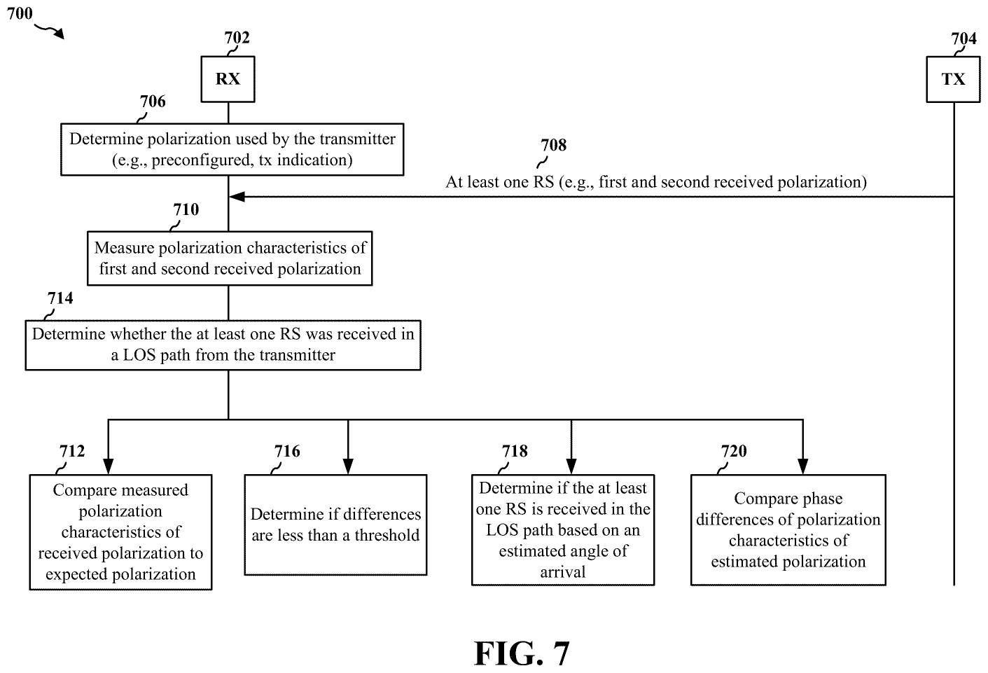

FIG. 7 is a call flow diagram 700 of signaling between a receiver (RX) 702 and a transmitter (TX) 704. The transmitter 704 may comprise a base station or a UE. The receiver 702 may comprise a base station or a UE. For example, in the context of FIG. 1, the receiver 702 may correspond to base station 102/180 or UE 104. Further, the transmitter 704 may correspond to at least UE 104 or to base station 102/180. In another example, in the context of FIG. 3, the receiver 702 may correspond to base station 310 and the transmitter 704 may correspond to UE 350.

At 706, the receiver determines a polarization used by a transmitter. The receiver may determine the polarization used by the transmitter for at least one RS. The transmitter may utilize the polarization to transmit the at least one RS to the receiver. In some aspects, the transmitter may provide an indication to the receiver that indicates the polarization used by the transmitter. In some aspects, the polarization used by the transmitter may be preconfigured within the receiver.

At 708, the transmitter 704 transmits the at least one RS to the receiver 702. The receiver 702 receives the at least one RS from the transmitter 704. The at least one RS may have a first received polarization in a first configuration and a second received polarization in a second configuration. The first and second configuration may be different or the same. In some aspects, the second configuration may be orthogonal to the first configuration. In some aspects, the first configuration and/or second configuration may comprise at least one of a circular polarization, a linear polarization, an elliptical polarization, or the like.

At 710, the receiver 702 measures polarization characteristics of the first received polarization and the second received polarization. The receiver 702 measures polarization characteristics of the first received polarization and the second received polarization of the at least one RS.

At 714, the receiver 702 determines whether the at least one RS was received in a LOS path from the transmitter. The receiver determines that the at least one RS was received in the LOS path from the transmitter based on measured polarization characteristics and expected received polarization characteristics. The expected received polarization characteristics may be based on a determined polarization used by the transmitter. The determined polarization used by the transmitter may be determined by the UE based on the polarization provided by the transmitter or preconfigured within the receiver.

In some aspects, to determine that the at least one RS was received in the LOS path from the transmitter, the receiver at 712, may compare the measured polarization characteristics of the first received polarization and the second received polarization to expected received polarization characteristics. The receiver may compare the measured polarization characteristics of the first received polarization and the second received polarization to the expected received polarization characteristics that may be based on the determined polarization used by the transmitter for the at least one RS. The expected received polarization characteristics may comprise a specific polarization utilized by the transmitter. In some aspects, the receiver may receive an indication from the transmitter indicating the specific polarization utilized by the transmitter. In some aspects, the receiver may be preconfigured with the specific polarization utilized by the transmitter. The polarization characteristics of the first received polarization or the second received polarization may comprise an amplitude and a phase.

In some aspects, the receiver, to compare the polarization characteristics, may determine a first difference between the polarization characteristics of the first received polarization and the expected received polarization characteristics. The receiver may determine if the first difference between the polarization characteristics of the first received polarization and the expected received polarization characteristics is less than a first threshold.

In some aspects, the receiver, to compare the polarization characteristics, may determine a second difference between the polarization characteristics of the second received polarization and the expected received polarization characteristics. The receiver may determine if the second difference between the polarization characteristics of the second received polarization and the expected received polarization characteristics is less than a second threshold. In some aspects, the first threshold and the second threshold may be a same threshold. In some aspects, the at least one RS may not be received in the LOS path from the transmitter if the first difference is greater than the first threshold. In some aspects, the at least one RS may not be received in the LOS path from the transmitter if the second difference is greater than the second threshold.

In some aspects, to determine that the at least one RS was received in the LOS path from the transmitter, the receiver at 716, may determine if differences are less than a threshold. For example, the receiver may determine that the at least one RS was received in the LOS path from the transmitter if both the first difference is less than the first threshold and the second difference is less than the second threshold. In some aspects, the polarization characteristics of the first and/or second received polarization may comprise at least one of a circular polarization, a linear polarization, or an elliptical polarization. In some aspects, the first configuration of the first received polarization or the second configuration of the second received polarization may comprise at least one of a circular polarization, a linear polarization, or an elliptical polarization. In some aspects, the first and second received polarizations may be observed, by the receiver, for a period of time that may exceed a designated period. In some aspects, the at least one RS may be transmitted across different antenna ports, where the polarization characteristics of the first or second received polarization may comprise at least one of circular polarization, elliptical polarization, or linear polarization. In some aspects, the polarization characteristics of the different antenna ports may vary with time in a pattern.

In some aspects, to determine whether the at least one RS was received in the LOS path, the receiver at 718, may determine if the at least one RS was received in the LOS path based on an estimated angle of arrival. For example, the receiver may estimate an angle of arrival of the at least one RS. The receiver, to determine whether the at least one RS was received in the LOS path, may then determine whether the at least one RS was received in the LOS path further based on an estimated angle of arrival. The receiver may include the estimated angle of arrival with the determination whether the at least one RS was received in the LOS path from the transmitter based on the measured polarization characteristics and the expected received polarization characteristics. The receiver may utilize the estimated angle of arrival in conjunction with the antenna configuration (e.g., alignment) of the receiver to determine whether the at least one RS was received in the LOS path from the transmitter.

In some aspects, to determine whether the at least one RS was received in the LOS path from the transmitter, the receiver at 720, may compare a phase difference between a first and a second measured polarization characteristic of the first and second received polarization to a phase difference between a first and a second polarization characteristic of the expected received polarization characteristics. In some aspects, the at least one RS was received in the LOS path if the phase difference is less than a threshold. In some aspects, the polarization characteristics of the first received polarization or the second received polarization may comprise an amplitude and a phase. At least one of the amplitude or the phase of the first received polarization or the second received polarization may be compared to the characteristics of the expected received polarization based on the determined polarization used by the transmitter.

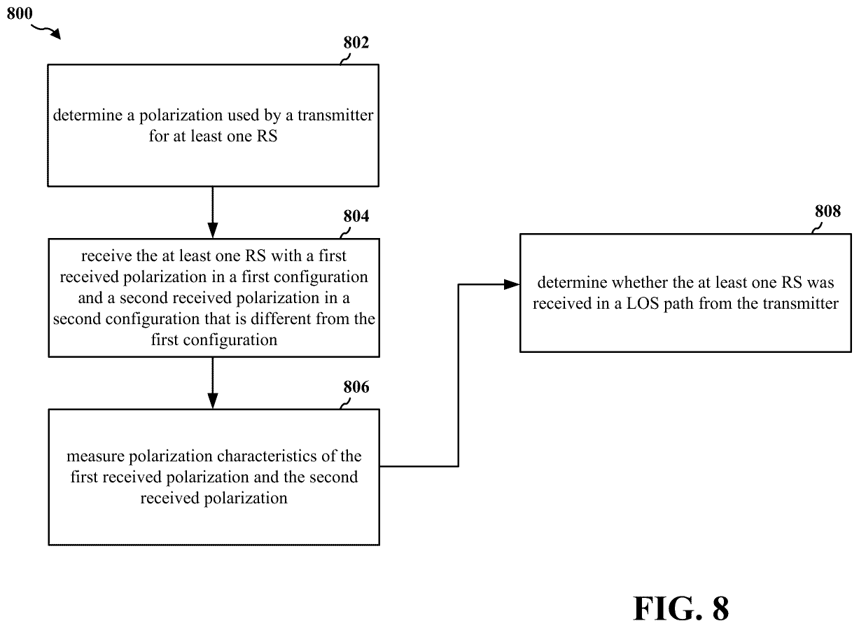

FIG. 8 is a flowchart 800 of a method of wireless communication. The method may be performed by a base station or a component of a base station (e.g., the base station 102/180). The method may be performed by a UE or a component of a UE (e.g., the UE 104); the apparatus 1002; or the baseband processor 1004. The baseband processor 1004 may include the memory 360 and which may be the entire UE 350 or a component of the UE 350, such as the TX processor 368, the RX processor 356, and/or the controller/processor 359. The baseband processor 1004 may include the memory 376 and which may be the entire base station 310 or a component of the base station 310, such as the TX processor 316, the RX processor 370, and/or the controller/processor 375. One or more of the illustrated operations may be omitted, transposed, or contemporaneous. The method may allow a receiver to determine a line of sight path based at least on polarization characteristics.

At 802, the receiver determines a polarization used by a transmitter. For example, 802 may be performed by determination component 1040 of apparatus 1002. The receiver may determine the polarization used by the transmitter for at least one RS. The transmitter may utilize the polarization to transmit the at least one RS to the receiver. In some aspects, the transmitter may provide an indication to the receiver that indicates the polarization used by the transmitter. In some aspects, the polarization used by the transmitter may be preconfigured within the receiver.

At 804, the receiver receives the at least one RS. For example, 804 may be performed by RS component 1042 of apparatus 1002. The receiver may receive the at least one RS from the transmitter. The at least one RS may have a first received polarization in a first configuration and a second received polarization in a second configuration. The first and second configuration may be different or the same. In some aspects, the second configuration may be orthogonal to the first configuration. In some aspects, the first configuration and/or second configuration may comprise at least one of a circular polarization, a linear polarization, an elliptical polarization, or the like.

At 806, the receiver measures polarization characteristics of the first received polarization and the second received polarization. For example, 806 may be performed by measurement component 1044 of apparatus 1002.

At 808, the receiver determines whether the at least one RS was received in a LOS path from the transmitter. For example, 808 may be performed by determination component 1040 of apparatus 1002. The receiver determines whether the at least one RS was received in the LOS path from the transmitter based on measured polarization characteristics and expected received polarization characteristics. The expected received polarization characteristics may be based on a determined polarization used by the transmitter. The determined polarization used by the transmitter may be determined by the UE based on the polarization provided by the transmitter or preconfigured within the receiver.

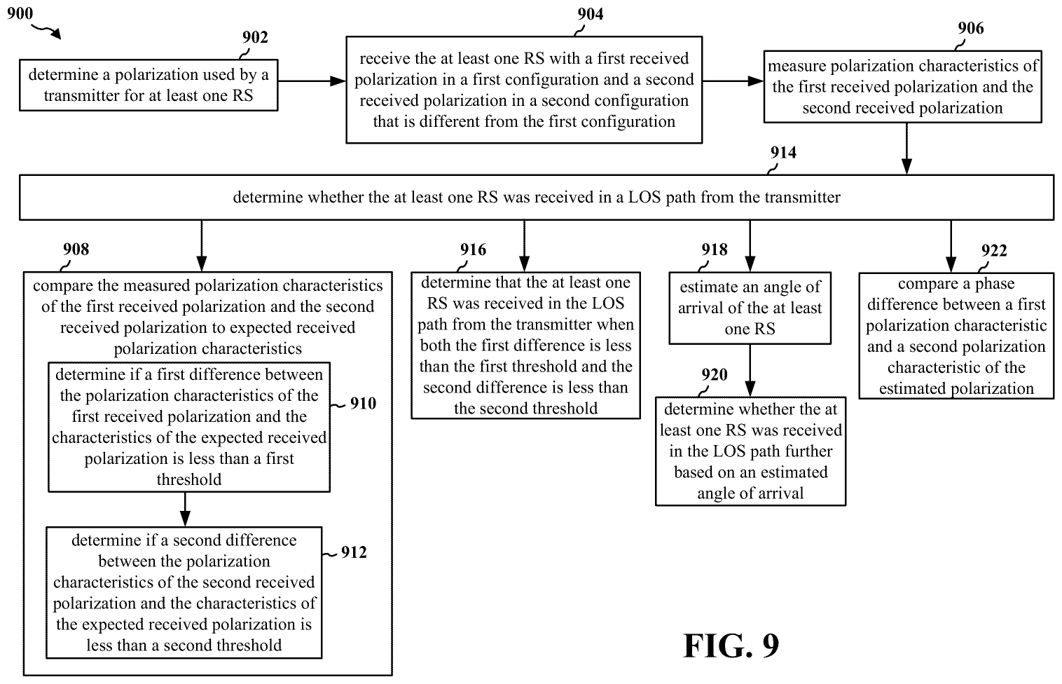

FIG. 9 is a flowchart 900 of a method of wireless communication. The method may be performed by a base station or a component of a base station (e.g., the base station 102/180). The method may be performed by a UE or a component of a UE (e.g., the UE 104); the apparatus 1002; or the baseband processor 1004. The baseband processor 1004 may include the memory 360 and which may be the entire UE 350 or a component of the UE 350, such as the TX processor 368, the RX processor 356, and/or the controller/processor 359. The baseband processor 1004 may include the memory 376 and which may be the entire base station 310 or a component of the base station 310, such as the TX processor 316, the RX processor 370, and/or the controller/processor 375. One or more of the illustrated operations may be omitted, transposed, or contemporaneous. The method may allow a receiver to determine a line of sight path based at least on polarization characteristics.

At 902, the receiver determines a polarization used by a transmitter. For example, 902 may be performed by determination component 1040 of apparatus 1002. The receiver may determine the polarization used by the transmitter for at least one RS. The transmitter may utilize the polarization to transmit the at least one RS to the receiver. In some aspects, the transmitter may provide an indication to the receiver that indicates the polarization used by the transmitter. In some aspects, the polarization used by the transmitter may be preconfigured within the receiver.

At 904, the receiver receives the at least one RS. For example, 904 may be performed by RS component 1042 of apparatus 1002. The receiver may receive the at least one RS from the transmitter. The at least one RS may have a first received polarization in a first configuration and a second received polarization in a second configuration. The first and second configuration may be different or the same. In some aspects, the second configuration may be orthogonal to the first configuration. In some aspects, the first configuration and/or second configuration may comprise at least one of a circular polarization, a linear polarization, an elliptical polarization, or the like.

At 906, the receiver measures polarization characteristics of the first received polarization and the second received polarization. For example, 906 may be performed by measurement component 1044 of apparatus 1002.

At 914, the receiver determines whether the at least one RS was received in a LOS path from the transmitter. For example, 914 may be performed by determination component 1040 of apparatus 1002. The receiver determines whether the at least one RS was received in the LOS path from the transmitter based on measured polarization characteristics and expected received polarization characteristics. The expected received polarization characteristics may be based on a determined polarization used by the transmitter. The determined polarization used by the transmitter may be determined by the UE based on the polarization provided by the transmitter or preconfigured within the receiver.

In some aspects, to determine that the at least one RS was received in the LOS path from the transmitter, the receiver at 908, may compare the measured polarization characteristics of the first received polarization and the second received polarization to expected received polarization characteristics. For example, 908 may be performed by comparison component 1046 of apparatus 1002. The receiver may compare the measured polarization characteristics of the first received polarization and the second received polarization to the expected received polarization characteristics that may be based on the determined polarization used by the transmitter for the at least one RS. The expected received polarization characteristics may comprise a specific polarization utilized by the transmitter. In some aspects, the receiver may receive an indication from the transmitter indicating the specific polarization utilized by the transmitter. In some aspects, the receiver may be preconfigured with the specific polarization utilized by the transmitter. The polarization characteristics of the first received polarization or the second received polarization may comprise an amplitude and a phase.

In some aspects, to compare the polarization characteristics, the receiver at 910, may determine a first difference between the polarization characteristics of the first received polarization and the expected received polarization characteristics. For example, 910 may be performed by determination component 1040 of apparatus 1002. The receiver may determine if the first difference between the polarization characteristics of the first received polarization and the expected received polarization characteristics is less than a first threshold.

In some aspects, to compare the polarization characteristics, the receiver at 912, may determine a second difference between the polarization characteristics of the second received polarization and the expected received polarization characteristics. For example, 912 may be performed by determination component 1040 of apparatus 1002. The receiver may determine if the second difference between the polarization characteristics of the second received polarization and the expected received polarization characteristics is less than a second threshold. In some aspects, the first threshold and the second threshold may be a same threshold. In some aspects, the at least one RS may not be received in the LOS path from the transmitter if the first difference is greater than the first threshold. In some aspects, the at least one RS may not be received in the LOS path from the transmitter if the second difference is greater than the second threshold.

In some aspects, to determine that the at least one RS was received in the LOS path from the transmitter, the receiver at 916, may determine that the at least one RS was received in the LOS path from the transmitter if both the first difference is less than the first threshold and the second difference is less than the second threshold. For example, 916 may be performed by determination component 1040 of apparatus 1002. The receiver may determine that the at least one RS may be received in the LOS path from the transmitter if both the first difference is less than the first threshold and the second difference is less than the second threshold. In some aspects, the polarization characteristics of the first and/or second received polarization may comprise at least one of a circular polarization, a linear polarization, or an elliptical polarization. In some aspects, the first configuration of the first received polarization or the second configuration of the second received polarization may comprise at least one of a circular polarization, a linear polarization, or an elliptical polarization. In some aspects, the first and second received polarizations may be observed, by the receiver, for a period of time that may exceed a designated period. In some aspects, the at least one RS may be transmitted across different antenna ports, where the polarization characteristics of the first or second received polarization may comprise at least one of circular polarization, elliptical polarization, or linear polarization. In some aspects, the polarization characteristics of the different antenna ports may vary with time in a pattern.

In some aspects, to determine whether the at least one RS was received in the LOS path, the receiver may determine if the at least one RS was received in the LOS path based on an estimated angle of arrival. For example, the receiver at 918, may estimate an angle of arrival of the at least one RS. For example, 918 may be performed by estimate component 1048 of apparatus 1002. At 920, the receiver, to determine whether the at least one RS was received in the LOS path, may determine whether the at least one RS was received in the LOS path further based on an estimated angle of arrival. For example, 920 may be performed by determination component 1040 of apparatus 1002. The receiver may include the estimated angle of arrival with the determination whether the at least one RS was received in the LOS path from the transmitter based on the measured polarization characteristics and the expected received polarization characteristics. The receiver may utilize the estimated angle of arrival in conjunction with the antenna configuration (e.g., alignment) of the receiver to determine whether the at least one RS was received in the LOS path from the transmitter.

In some aspects, to determine whether the at least one RS was received in the LOS path from the transmitter, the receiver at 922, may compare a phase difference between a first and a second measured polarization characteristic of the first and second received polarization to a phase difference between a first and a second polarization characteristic of the expected received polarization characteristics. For example, 922 may be performed by comparison component 1046 of apparatus 1002. In some aspects, the at least one RS was received in the LOS path if the phase difference is less than a threshold. In some aspects, the polarization characteristics of the first received polarization or the second received polarization may comprise an amplitude and a phase. At least one of the amplitude or the phase of the first received polarization or the second received polarization may be compared to the characteristics of the expected received polarization based on the determined polarization used by the transmitter.

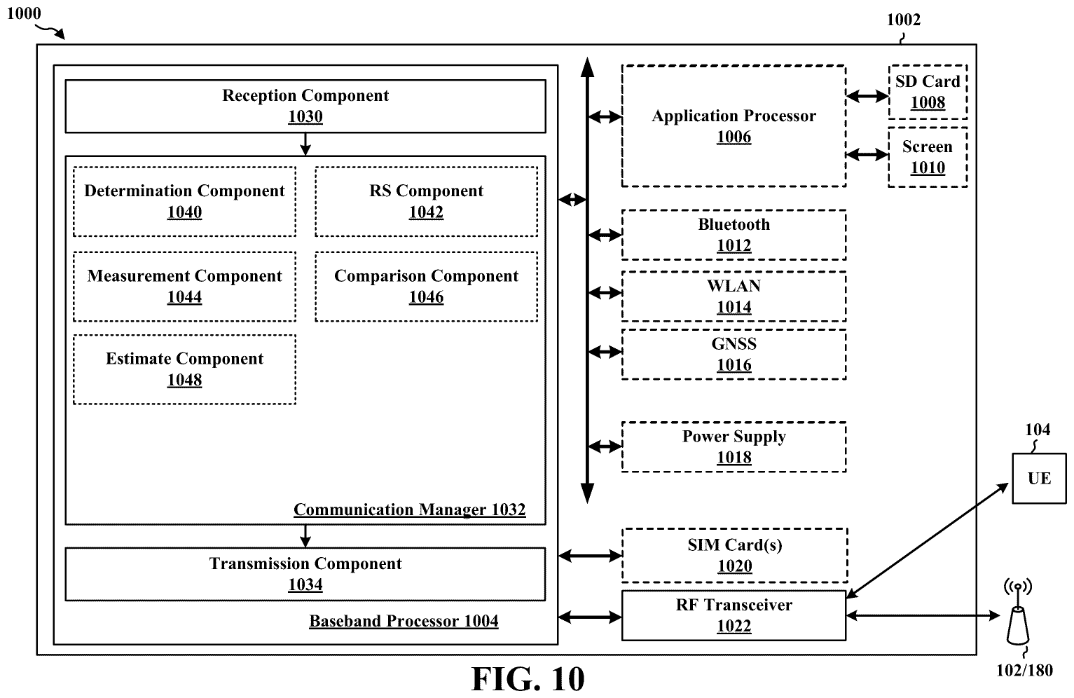

FIG. 10 is a diagram 1000 illustrating an example of a hardware implementation for an apparatus 1002. The apparatus 1002 may be a base station, a component of a base station, or may implement base station functionality. The apparatus 1002 may be a UE, a component of a UE, or may implement UE functionality. In some aspects, the apparatus 1002 may include a baseband processor 1004 (also referred to as a modem) coupled to an RF transceiver 1022. In some aspects, the apparatus 1002 may further include one or more subscriber identity modules (SIM) cards 1020, an application processor 1006 coupled to a secure digital (SD) card 1008 and a screen 1010, a Bluetooth module 1012, a wireless local area network (WLAN) module 1014, a global navigation satellite systems (GNSS) module 1016, or a power supply 1018. The GNSS module 1516 may comprise a variety of satellite positioning systems. For example, the GNSS module may correspond to Global Positioning System (GPS), Global Navigation Satellite System (GLONASS), Galileo, BeiDou Navigation Satellite System (BDS), Wide Area Augmentation System (WAAS), European Geostationary Navigation Overlay Service (EGNOS), GPS Aided GEO Augmented Navigation (GAGAN), Multifunctional Transport Satellites (MTSAT) Satellite Augmentation System (MSAS), Quasi-Zenith Satellite System (QZSS), or Navigation with Indian Constellation (NavIC). The baseband processor 1004 communicates through the RF transceiver 1022 with the UE 104 and/or BS 102/180. The baseband processor 1004 may include a computer-readable medium/memory. The computer-readable medium/memory may be non-transitory. The baseband processor 1004 is responsible for general processing, including the execution of software stored on the computer-readable medium/memory. The software, when executed by the baseband processor 1004, causes the baseband processor 1004 to perform the various functions described supra. The computer-readable medium/memory may also be used for storing data that is manipulated by the baseband processor 1004 when executing software. The baseband processor 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the baseband processor 1004. The baseband processor 1004 may be a component of the UE 350 and may include the memory 360 and/or at least one of the TX processor 368, the RX processor 356, and the controller/processor 359. In one configuration, the apparatus 1002 may be a modem chip and include just the baseband processor 1004, and in another configuration, the apparatus 1002 may be the entire UE (e.g., see 350 of FIG. 3) and include the additional modules of the apparatus 1002.

The communication manager 1032 includes a determination component 1040 that is configured to determine a polarization used by a transmitter, e.g., as described in connection with 802 of FIG. 8 or 902 of FIG. 9. The determination component 1040 may be further configured to determine a first difference between the polarization characteristics of the first received polarization and the expected received polarization characteristics, e.g., as described in connection with 910 of FIG. 9. The determination component 1040 may be further configured to determine a second difference between the polarization characteristics of the second received polarization and the expected received polarization characteristics, e.g., as described in connection with 912 of FIG. 9. The determination component 1040 may be further configured to determine whether the at least one RS was received in the LOS path from the transmitter, e.g., as described in connection with 808 of FIG. 8 or 914 of FIG. 9. The determination component 1040 may be further configured to determine that the at least one RS was received in the LOS path from the transmitter if both the first difference is less than the first threshold and the second difference is less than the second threshold, e.g., as described in connection with 916 of FIG. 9. The determination component 1040 may be further configured to determine whether the at least one RS was received in the LOS path further based on an estimated angle of arrival, e.g., as described in connection with 920 of FIG. 9. The communication manager 1032 further includes an RS component 1042 that is configured to receive the at least one RS, e.g., as described in connection with 804 of FIG. 8 or 904 of FIG. 9. The communication manager 1032 further includes a measurement component 1044 that is configured to measure polarization characteristics of the first received polarization and the second received polarization, e.g., as described in connection with 806 of FIG. 8 or 906 of FIG. 9. The communication manager 1032 further includes a comparison component 1046 that is configured to compare the measured polarization characteristics of the first received polarization and the second received polarization to expected received polarization characteristics, e.g., as described in connection with 908 of FIG. 9. The comparison component 1046 may be further configured to compare a phase difference between first and second measured polarization characteristics of the first and second received polarizations to a phase difference between a first polarization characteristic and a second polarization characteristic of the expected received polarization characteristic, e.g., as described in connection with 922 of FIG. 9. The communication manager 1032 further includes an estimate component 1048 that is configured to estimate an angle of arrival of the at least one RS, e.g., as described in connection with 918 of FIG. 9.

The apparatus may include additional components that perform each of the blocks of the algorithm in the flowcharts of FIGS. 8 and 9. As such, each block in the flowcharts of FIGS. 8 and 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1002 may include a variety of components configured for various functions. In one configuration, the apparatus 1002, and in particular the baseband processor 1004, includes means for determining a polarization used by a transmitter for at least one RS. The apparatus includes means for receiving the at least one RS with a first received polarization in a first configuration and a second received polarization in a second configuration that is different from the first configuration. The apparatus includes means for measuring polarization characteristics of the first received polarization and the second received polarization. The apparatus includes means for determining whether the at least one RS was received in a LOS path from the transmitter based on measured polarization characteristics and expected received polarization characteristics. The expected received polarization characteristics are based on a determined polarization used by the transmitter. The apparatus further includes means for comparing the polarization characteristics of the first received polarization and the second received polarization to the expected received polarization characteristics. The apparatus further includes means for determining if a first difference between the polarization characteristics of the first received polarization and the characteristics of the expected received polarization is less than a first threshold. The apparatus further includes means for determining if a second difference between the polarization characteristics of the second received polarization and the characteristics of the expected received polarization is less than a second threshold. The apparatus further includes means for determining that the at least one RS was received in the LOS path from the transmitter if both the first difference is less than the first threshold and the second difference is less than the second threshold. The apparatus further includes means for estimating an angle of arrival of the at least one RS. The apparatus further includes means for determining whether the at least one RS was received in the LOS path further based on an estimated angle of arrival. The apparatus further includes means for comparing a phase difference between first and second measured polarization characteristics of the first and second received polarizations to a phase difference between a first polarization characteristic and a second polarization characteristic of the expected received polarization characteristics. The means may be one or more of the components of the apparatus 1002 configured to perform the functions recited by the means. As described supra, the apparatus 1002 may include the TX Processor 368, the RX Processor 356, and the controller/processor 359. As such, in one configuration, the means may be the TX Processor 368, the RX Processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a receiver including at least one processor coupled to a memory and at least one transceiver and configured to determine a polarization used by a transmitter for at least one RS; receive the at least one RS with a first received polarization in a first configuration and a second received polarization in a second configuration that is different from the first configuration; measure polarization characteristics of the first received polarization and the second received polarization; and determine whether the at least one RS was received in the LOS path from the transmitter based on measured polarization characteristics and expected received polarization characteristics, wherein the expected received polarization characteristics are based on a determined polarization used by the transmitter.

Aspect 2 is the apparatus of aspect 1, further includes that the at least one processor is further configured to compare the polarization characteristics of the first received polarization and the second received polarization to the expected received polarization characteristics.

Aspect 3 is the apparatus of any of aspects 1 and 2, further includes that to compare the polarization characteristics the at least one processor is further configured to determine if a first difference between the polarization characteristics of the first received polarization and the characteristics of the expected received polarization is less than a first threshold; and determine if a second difference between the polarization characteristics of the second received polarization and the characteristics of the expected received polarization is less than a second threshold.

Aspect 4 is the apparatus of any of aspects 1-3, further includes that the first threshold and the second threshold are a same threshold to determine that the at least one RS was received LOS from the transmitter based on the comparison the at least one processor is further configured to determine that the at least one RS was received LOS from the transmitter when both the first difference is less than the first threshold and the second difference is less than the second threshold.

Aspect 5 is the apparatus of any of aspects 1-4, further includes that to determine that the at least one RS was received in the LOS path from the transmitter the at least one processor is further configured to determine that the at least one RS was received in the LOS path from the transmitter if both the first difference is less than the first threshold and the second difference is less than the second threshold.

Aspect 6 is the apparatus of any of aspects 1-5, further includes that the first configuration of the first received polarization or the second configuration of the second received polarization comprises at least one of a circular polarization, a linear polarization, or an elliptical polarization.

Aspect 7 is the apparatus of any of aspects 1-6, further includes that the first and second received polarizations are observed for a period of time that exceeds a designated period.

Aspect 8 is the apparatus of any of aspects 1-7, further includes that the at least one RS is transmitted across different antenna ports, wherein the polarization characteristics of the first or second received polarization comprise at least one of circular polarization, elliptical polarization, or linear polarization.

Aspect 9 is the apparatus of any of aspects 1-8, further includes that the polarization characteristics of the different antenna ports varies with time in a pattern.

Aspect 10 is the apparatus of any of aspects 1-9, further includes that the at least one RS is not received in the LOS path from the transmitter if the first difference is greater than the first threshold or the second difference is greater than the second threshold.

Aspect 11 is the apparatus of any of aspects 1-10, further includes that to determine whether the at least one RS was received in the LOS path, the at least one processor is further configured to estimate an angle of arrival of the at least one RS; and determine whether the at least one RS was received in the LOS path further based on an estimated angle of arrival.

Aspect 12 is the apparatus of any of aspects 1-11, further includes that to determine whether the at least one RS was received in the LOS path, the at least one processor is further configured to compare a phase difference between first and second measured polarization characteristics of the first and second received polarizations to a phase difference between a first polarization characteristic and a second polarization characteristic of the expected received polarization characteristics.

Aspect 13 is the apparatus of any of aspects 1-12, further includes that the at least one RS was received in the LOS path if the phase difference is less than a threshold.

Aspect 14 is the apparatus of any of aspects 1-13, further includes that the polarization characteristics of the first received polarization or the second received polarization comprise an amplitude and a phase.

Aspect 15 is the apparatus of any of aspects 1-14, further includes that at least one of the amplitude or the phase of the first received polarization or the second received polarization is compared to the characteristics of the expected received polarization based on the determined polarization used by the transmitter.

Aspect 16 is the apparatus of any of aspects 1-15, further includes that the polarization used by the transmitter is provided to the receiver or is preconfigured and known to the receiver.

Aspect 17 is a method of wireless communication for implementing any of aspects 1-16.

Aspect 18 is an apparatus for wireless communication including means for implementing any of aspects 1-16.

Aspect 19 is a computer-readable medium storing computer executable code, where the code when executed by a processor causes the processor to implement any of aspects 1-16.

What is claimed is:

1. An apparatus for wireless communication at a receiver, comprising:
a memory;
at least one transceiver; and
at least one processor, communicatively connected to the memory and the at least one transceiver, the at least one processor configured to:
determine a polarization used by a transmitter for at least one reference signal (RS);
receive the at least one RS with a first received polarization in a first configuration and a second received polarization in a second configuration that is different from the first configuration;
measure polarization characteristics of the first received polarization and the second received polarization; and
determine whether the at least one RS was received in a line-of-sight (LOS) path from the transmitter based on the measured polarization characteristics and expected received polarization characteristics, wherein the expected received polarization characteristics are based on the determined polarization used by the transmitter.

2. The apparatus of claim 1, wherein, to determine whether the at least one RS was received in the LOS path, the at least one processor is further configured to:
compare the measured polarization characteristics of the first received polarization and the second received polarization to the expected received polarization characteristics.

3. The apparatus of claim 2, wherein, to compare the polarization characteristics, the at least one processor is further configured to:
determine if a first difference between the polarization characteristics of the first received polarization and the characteristics of the expected received polarization is less than a first threshold; and
determine if a second difference between the polarization characteristics of the second received polarization and the characteristics of the expected received polarization is less than a second threshold.

4. The apparatus of claim 3, wherein the first threshold and the second threshold are a same threshold.

5. The apparatus of claim 3, wherein, to determine that the at least one RS was received in the LOS path from the transmitter, the at least one processor is further configured to:
determine that the at least one RS was received in the LOS path from the transmitter when both the first difference is less than the first threshold and the second difference is less than the second threshold.

6. The apparatus of claim 5, wherein the first configuration of the first received polarization or the second configuration of the second received polarization comprises at least one of a circular polarization, a linear polarization, or an elliptical polarization.

7. The apparatus of claim 6, wherein the first and second received polarizations are observed for a period of time that exceeds a designated period.

8. The apparatus of claim 5, wherein the at least one RS is transmitted across different antenna ports, wherein the polarization characteristics of the first or second received polarization comprise at least one of circular polarization, elliptical polarization, or linear polarization.

9. The apparatus of claim 8, wherein the polarization characteristics of the different antenna ports varies with time in a pattern.

10. The apparatus of claim 3, wherein the at least one RS is not received in the LOS path from the transmitter if the first difference is greater than the first threshold or the second difference is greater than the second threshold.

11. The apparatus of claim 1, wherein, to determine whether the at least one RS was received in the LOS path, the at least one processor is further configured to:
estimate an angle of arrival of the at least one RS; and
determine whether the at least one RS was received in the LOS path further based on an estimated angle of arrival.

12. The apparatus of claim 2, wherein, to determine whether the at least one RS was received in the LOS path, the at least one processor is further configured to:
compare a phase difference between first and second measured polarization characteristics of the first and second received polarizations to a phase difference between a first polarization characteristic and a second polarization characteristic of the expected received polarization characteristics.

13. The apparatus of claim 12, wherein the at least one RS was received in the LOS path if the phase difference is less than a threshold.

14. The apparatus of claim 12, wherein the polarization characteristics of the first received polarization or the second received polarization comprise an amplitude and a phase.

15. The apparatus of claim 14, wherein at least one of the amplitude or the phase of the first received polarization or the second received polarization is compared to the characteristics of the expected received polarization based on the determined polarization used by the transmitter.

16. The apparatus of claim 1, wherein the polarization used by the transmitter is provided to the apparatus or is preconfigured and known to the apparatus.

17. A method of wireless communication at a receiver, comprising:
determining a polarization used by a transmitter for at least one reference signal (RS);
receiving the at least one RS with a first received polarization in a first configuration and a second received polarization in a second configuration that is different from the first configuration;
measuring polarization characteristics of the first received polarization and the second received polarization; and
determining whether the at least one RS was received in a line-of-sight (LOS) path from the transmitter based on the measured polarization characteristics and expected received polarization characteristics, wherein the expected received polarization characteristics are based on the determined polarization used by the transmitter.

18. The method of claim 17, wherein determining whether the at least one RS was received in the LOS path comprises:
comparing the measured polarization characteristics of the first received polarization and the second received polarization to the expected received polarization characteristics.

19. The method of claim 18, wherein the comparing comprising:
determining if a first difference between the polarization characteristics of the first received polarization and the characteristics of the expected received polarization is less than a first threshold; and
determining if a second difference between the polarization characteristics of the second received polarization and the characteristics of the expected received polarization is less than a second threshold.

20. The method of claim 19, wherein the first threshold and the second threshold are a same threshold.

21. The method of claim 19, wherein the determining whether the at least one RS was received in the LOS path from the transmitter comprises:
determining that the at least one RS was received in the LOS path from the transmitter when both the first difference is less than the first threshold and the second difference is less than the second threshold.

22. The method of claim 21, wherein the first configuration of the first received polarization or the second configuration of the second received polarization comprises at least one of a circular polarization, a linear polarization, or an elliptical polarization, wherein the polarization of the first and second received polarizations are observed for a period of time that exceeds a designated period.

23. The method of claim 21, wherein the at least one RS is transmitted across different antenna ports, wherein the polarization characteristics of the first or second received polarization comprise at least one of circular polarization, elliptical polarization, or linear polarization.

24. The method of claim 23, wherein the polarization characteristics of the different antenna ports varies with time in a pattern.

25. The method of claim 19, wherein the at least one RS is not received in the LOS path from the transmitter if the first difference is greater than the first threshold or the second difference is greater than the second threshold.

26. The method of claim 17, further comprising:
estimating an angle of arrival of the at least one RS; and
determining whether the at least one RS was received in the LOS path further based on an estimated angle of arrival.

27. The method of claim 18, wherein the determining whether the at least one RS was received in the LOS path from the transmitter comprises:
comparing a phase difference between first and second measured polarization characteristics of the first and second received polarization to a phase difference between a first polarization characteristic and a second polarization characteristic of the expected received polarization characteristics.

28. The method of claim 27, wherein the at least one RS was received in the LOS path if the phase difference is less than a threshold.

29. An apparatus for wireless communication at a receiver, comprising:
means for determining a polarization used by a transmitter for at least one reference signal (RS);
means for receiving the at least one RS with a first received polarization in a first configuration and a second received polarization in a second configuration that is different from the first configuration;
means for measuring polarization characteristics of the first received polarization and the second received polarization; and
means for determining whether the at least one RS was received in a line-of-sight (LOS) path from the transmitter based on the measured polarization characteristics and expected received polarization characteristics, wherein the expected received polarization characteristics are based on the determined polarization used by the transmitter.

30. A computer-readable medium storing computer executable code at a receiver, the code when executed by a processor causes the processor to:
determine a polarization used by a transmitter for at least one reference signal (RS);
receive the at least one RS with a first received polarization in a first configuration and a second received polarization in a second configuration that is different from the first configuration;
measure polarization characteristics of the first received polarization and the second received polarization; and
determine whether the at least one RS was received in a line-of-sight (LOS) path from the transmitter based on the measured polarization characteristics and expected received polarization characteristics, wherein the expected received polarization characteristics are based on the determined polarization used by the transmitter.
